(19) United States
(12) Patent Application Publication
(10) Pub. No.: US 2019/0367789 A1
(43) Pub. Date: Dec. 5, 2019

(54) COMPOSITION COMPRISING 2,3,3,3-TETRAFLUOROPROPENE

(71) Applicant: Arkema France, Colombes (FR)

(72) Inventor: Wissam RACHED, Chaponost (FR)

(73) Assignee: Arkema France, Colombes (FR)

(21) Appl. No.: 16/477,318

(22) PCT Filed: Jan. 18, 2018
(86) PCT No.: PCT/FR2018/050125

§ 371 Date: Jul. 11, 2019

(30) Foreign Application Priority Data
Jan. 19, 2017 (FR) 1750415

(51) Int. Cl. C09K 5/04

(52) U.S. Cl. CPC C09K 5/045; C09K 2205/22; C09K 2205/126; F25B 1/00; C09K 2205/12; C09K 2205/40; C09K 2205/122

(57) ABSTRACT

The invention relates to a composition comprising between 74 wt. % and 80 wt. % of 2,3,3,3-tetrafluoropropene, between 19 wt. % and 25 wt. % of difluoromethane, and between 1 and 1.9 wt. % of propane, in relation to the total weight of the composition. The invention also relates to various uses of said composition, particularly in the field of refrigeration, air-conditioning or heat pumps.

### FIELD OF THE INVENTION

The present invention relates to a composition comprising 2,3,3,3-tetrafluoropropene, and uses thereof as heat transfer fluids, in particular for refrigeration, air conditioning and heat pumps.

Fluids based on fluorocarbon compounds are widely used in many industrial devices, in particular for air conditioning, heat pumps or refrigeration. These devices share that they are based on a thermodynamic cycle comprising the vaporization of the fluid at a low pressure (in which the fluid absorbs heat); the compression of the vaporized fluid up to a high pressure; the condensation of the vaporized fluid into liquid at high pressure (in which the fluid gives off heat); and the expansion of the fluid to complete the cycle.

The choice of a heat transfer fluid (which can be a pure compound or a mixture of compounds) is dictated on the one hand by the thermodynamic properties of the fluid, and on the other hand by additional constraints.

In particular, depending on the flammability of the fluid, more or less restrictive safety measures must be taken to use this fluid in certain applications, or the use of this fluid can even be prohibited in other applications.

Another important criterion is that of the impact of the considered fluid on the environment. Thus, chlorinated compounds (chlorofluorocarbons and hydrochlorofluorocarbons) have the drawback of damaging the ozone layer. As a result, non-chlorinated compounds are generally preferred to them, such as hydrofluorocarbons, fluoroethers and, more recently, fluoroolefins (or fluoroalkenes). Fluoroolefins further generally have a short lifetime, and therefore a lower global warming potential (GWP) than the other compounds.

In this respect, documents WO 2004/037913 and WO 2005/105947 teach the use of compositions comprising at least one fluoroalkene having three or four carbon atoms, in particular pentafluoropropene and tetrafluoropropene, as heat transfer fluids.

Documents WO 2007/053697 and WO 2007/126414 disclose mixtures of fluoroolefins and other heat transfer compounds as heat transfer fluids.

However, olefin compounds tend to be more flammable than saturated compounds.

Therefore a real need exists to obtain and use less flammable heat transfer fluids than those of the state of the art, while having a low GWP, preferably below 150.

### DESCRIPTION OF THE INVENTION

The present invention relates to a composition comprising (preferably constituted of) between 74 wt % to 80 wt % of 2,3,3,3-tetrafluoropropene (HFO-1234yf), from 19 wt % to 25 wt % of difluoromethane (HFC-32), and from 1 to 1.9 wt % of propane (preferably from 1 to 1.8 wt % of propane), relative to the total weight of the composition.

Preferably, the composition according to the invention is such that the total sum of the weight contents of 2,3,3,3-tetrafluoropropene (HFO-1234yf), difluoromethane (HFC-32) and propane is equal to 100%.

Preferably, the weight content of propane in the composition is for example between 1.1% and 1.9%, 1.2% and 1.9%, 1.3% and 1.9%, 1.4% and 1.9%, 1.5% and 1.9%, 1.6% and 1.9%, 1.7% and 1.9%, 1.8% and 1.9%, 1.1% and 1.8%, 1.1% and 1.7%, 1.1% and 1.6%, 1.1% and 1.5%, 1.1% and 1.4%, 1.1% and 1.3%, 1.1% and 1.2%, 1.2% and 1.8%, 1.2% and 1.7%, 1.2% and 1.6%, 1.2% and 1.5%, 1.2% and 1.4%, 1.2% and 1.3%, 1.3% and 1.8%, 1.3% and 1.7%, 1.3% and 1.6%, 1.3% and 1.5%, 1.3% and 1.4%, 1.4% and 1.8%, 1.4% and 1.7%, 1.4% and 1.6%, 1.4% and 1.5%, 1.5% and 1.8%, 1.5% and 1.7%, 1.5% and 1.6%, 1.6% and 1.8%, 1.6% and 1.7%, or between 1.7% and 1.8%. Preferably, the weight content of propane in the composition is 1.7% or 1.8%.

Preferably, the weight content of 2,3,3,3-tetrafluoropropene in the composition according to the invention is for example between 74% and 79%, 74% and 78%, 74.1% and 78%, 74.2% and 78%, 74.3% and 80%, 74.5% and 78%, 74.6% and 78%, 74.7% and 78%, 74.8% and 78%, 74.9% and 78%, 75% and 78%, 75.1% and 78%, 75.2% and 78%, 75.3% and 78%, 75.4% and 78%, 75.5% and 78%, 75.6% and 78%, 75.7% and 78%, 75.8% and 78%, 75.9% and 78%, 76% and 78%, 74% and 77.5%, 74% and 77%, 74% and 76.9%, 74% and 76.8%, 74 and 76.7%, 74% and 76.6%, 74% and 76.5%, 74% and 76.4%, 74% and 76.3%, 74% and 76.2%, 74% and 76.1%, 74% and 76%, 74.5% and 77.5%, 74.5% and 77%, 75% and 77.5%, or between 75% and 77%. Preferably, the weight content of 2,3,3,3-tetrafluoropropene in the composition according to the invention is between 76% and 78%.

Preferably, the weight content of difluoromethane in the composition according to the invention is for example between 19% and 24%, 19.5% and 24%, 20% and 24%, 20.5% and 24%, 21% and 24%, 21.5% and 24%, 19% and 23.5%, 19.5% and 23.5%, 20% and 23.5%, 20.5% and 23.5%, 21% and 23.5%, 21.5% and 23.5%, 19% and 23%, 19.5% and 23%, 20% and 23%, 20.5% and 23%, 21% and 23%, 21.5% and 23%, 19% and 22.5%, 19.5% and 22.5%, 20% and 22.5%, 20.5% and 22.5%, 21% and 22.5%, 21.5% and 22.5%, 19% and 22%, 19.5% and 22%, 20% and 22%, 20.5% and 22%, 21% and 22%, or between 21.5% and 22%.

According to one embodiment, the composition according to the invention comprises (preferably is constituted of) from 74.1 wt % to 79.1 wt % of 2,3,3,3-tetrafluoropropene (HFO-1234yf), from 19 wt % to 24 wt % of difluoromethane (HFC-32), and from 1 to 1.9 wt % of propane (preferably from 1 to 1.8 wt % of propane), relative to the total weight of the composition.

According to one embodiment, the composition according to the invention comprises (preferably is constituted of) from 74 wt % to 80 wt % of 2,3,3,3-tetrafluoropropene (HFO-1234yf), from 19 wt % to 25 wt % of difluoromethane (HFC-32), and propane in one of the following content levels: 1%, 1.1%, 1.2%, 1.3%, 1.4%, 1.5%, 1.6%, 1.7%, 1.8% or 1.9% relative to the total weight of the composition.

According to one embodiment, the composition according to the invention comprises (preferably is constituted of) from 74.1 wt % to 79.1 wt % of 2,3,3,3-tetrafluoropropene (HFO-1234yf), from 19 wt % to 24 wt % of difluoromethane (HFC-32), and propane in one of the following content levels: 1%, 1.1%, 1.2%, 1.3%, 1.4%, 1.5%, 1.6%, 1.7%, 1.8% or 1.9% relative to the total weight of the composition.

According to one embodiment, the composition according to the invention comprises (preferably is constituted of) from 76 wt % to 79 wt % of 2,3,3,3-tetrafluoropropene (HFO-1234yf), from 20 wt % to 23 wt % of difluoromethane (HFC-32), and from 1% to 1.9 wt % of propane (preferably from 1 to 1.8 wt % of propane), relative to the total weight of the corn position.

According to one embodiment, the composition according to the invention comprises (preferably is constituted of) from 76.5 wt % to 78.5 wt % of 2,3,3,3-tetrafluoropropene (HFO-1234yf), from 20 wt % to 22 wt % of difluoromethane (HFC-32), and from 1% to 1.9 wt % of propane (preferably from 1 to 1.8 wt % of propane), relative to the total weight of the corn position.

According to one embodiment, the composition according to the invention comprises (preferably is constituted of) from 76 wt % to 79 wt % of 2,3,3,3-tetrafluoropropene (HFO-1234yf), from 20 wt % to 23 wt % of difluoromethane (HFC-32), and propane in one of the following content levels: 1%, 1.1%, 1.2%, 1.3%, 1.4%, 1.5%, 1.6%, 1.7%, 1.8% or 1.9% relative to the total weight of the composition.

One preferred composition according to the invention is the following: 76.7 wt % (±0.5%) of 2,3,3,3-tetrafluoropropene, 21.5 wt % (±0.5%) of difluoromethane, and 1.8 wt % (±0.1%) of propane, relative to the total weight of the composition.

One preferred composition according to the invention is the following: 76.7 wt % of 2,3,3,3-tetrafluoropropene, 21.5 wt % of difluoromethane, and 1.8 wt % of propane, relative to the total weight of the composition.

One preferred composition according to the invention is the following: 76.6 wt % of 2,3,3,3-tetrafluoropropene, 21.5 wt % of difluoromethane, and 1.9 wt % of propane, relative to the total weight of the composition.

One preferred composition according to the invention is the following: 77.3 wt % (±0.5%) of 2,3,3,3-tetrafluoropropene, 21.5 wt % (±0.5%) of difluoromethane, and 1.2 wt % (±0.2%) of propane, relative to the total weight of the composition.

One preferred composition according to the invention is the following: 77.5 wt % of 2,3,3,3-tetrafluoropropene, 21.5 wt % of difluoromethane, and 1.0 wt % of propane, relative to the total weight of the composition.

One preferred composition according to the invention is the following: 77.3 wt % of 2,3,3,3-tetrafluoropropene, 21.5 wt % of difluoromethane, and 1.2 wt % of propane, relative to the total weight of the composition.

One preferred composition according to the invention is the following: 77.1 wt % of 2,3,3,3-tetrafluoropropene, 21.5 wt % of difluoromethane, and 1.4 wt % of propane, relative to the total weight of the composition.

One preferred composition according to the invention is the following: 77.6 wt % of 2,3,3,3-tetrafluoropropene, 21.0 wt % of difluoromethane, and 1.4 wt % of propane, relative to the total weight of the composition.

One preferred composition according to the invention is the following: 77.0 wt % (±0.5%) of 2,3,3,3-tetrafluoropropene, 21.5 wt % (±0.5%) of difluoromethane, and 1.5 wt % (±0.4%) of propane, relative to the total weight of the composition.

One preferred composition according to the invention is the following: 77.3 wt % of 2,3,3,3-tetrafluoropropene, 21.0 wt % of difluoromethane, and 1.7 wt % of propane, relative to the total weight of the composition.

One preferred composition according to the invention is the following: 76.8 wt % of 2,3,3,3-tetrafluoropropene, 21.5 wt % of difluoromethane, and 1.7 wt % of propane, relative to the total weight of the composition.

One preferred composition according to the invention is the following: 77.2 wt % of 2,3,3,3-tetrafluoropropene, 21.0 wt % of difluoromethane, and 1.8 wt % of propane, relative to the total weight of the composition.

One preferred composition according to the invention is the following: 76.7 wt % of 2,3,3,3-tetrafluoropropene, 21.5 wt % of difluoromethane, and 1.8 wt % of propane, relative to the total weight of the composition.

One preferred composition according to the invention is the following: 77.1 wt % of 2,3,3,3-tetrafluoropropene, 21.0 wt % of difluoromethane, and 1.9 wt % of propane, relative to the total weight of the composition.

One preferred composition according to the invention is the following: 76.6 wt % of 2,3,3,3-tetrafluoropropene, 21.5 wt % of difluoromethane, and 1.9 wt % of propane, relative to the total weight of the composition.

The compositions according to the invention are advantageously only slightly or not at all flammable.

The compositions according to the invention advantageously have a flame spread rate of less than 10 cm/s, preferably less than or equal to 9.5 cm/s, preferably less than or equal to 9 cm/s, advantageously less than or equal to 8.5 cm/s, and in particular less than or equal to 8 cm/s.

The compositions according to the invention advantageously lead to a “WCFF” composition (after leak) having a flame spread rate of less than 10 cm/s, preferably less than or equal to 9.5 cm/s, preferably less than or equal to 9 cm/s, advantageously less than or equal to 8.5 cm/s, and in particular less than or equal to 8 cm/s.

A so-called “WCF” (“worst case of formulation for flammability”) composition is defined in standard ASHRAE 34-2013 as being a formulation composition whose flame spread rate is highest. This composition is very close to the nominal composition with a certain tolerance.

A so-called “WCFF” (“worst case of fractionation for flammability”) composition is defined in standard ASHRAE 34-2013 as being a composition whose flame spread rate is highest. This composition is determined using a method that is well defined in the same standard.

The compositions according to the invention advantageously have a good compromise between good energy performance, low or nil flammability, and low GWP.

The compositions according to the invention advantageously have a GWP below 150, preferably below 148.

Due to their low flammability, the compositions according to the invention are advantageously safer when they are used as heat transfer fluids for refrigeration, air-conditioning and heating.

In the context of the present invention, the flammability and flame spread rate are defined and determined according to the test appearing in standard ASHRAE 34-2013, which refers to standard ASTM E 681 regarding the equipment used.

The test method described in standard ASHRAE 34-2013 is that developed in the thesis by T. Jabbour, “Classification de l'inflammabilité des fluides frigorigenes basée sur la vitesse fondamentale de flamme” under the oversight of Denis Clodic. Thesis, Paris, 2004.

The experimental device in particular uses the vertical glass tube method (tube number 2, length 150 cm, diameter 40 cm). Using two tubes makes it possible to conduct two tests with the same concentration at the same time. The tubes are in particular provided with tungsten electrodes, the latter are placed at the bottom of each tube, 6.35 mm (¼ inch) apart, and are connected to a 15 kV, 30 mA generator.

The different tested compositions are qualified as flammable or not flammable as such, according to the criteria defined in standard ASHRAE 34-2013.

The composition according to the invention is advantageously classified 2L according to standard ASHRAE 34-2013. According to this standard, classification 2L requires a flame spread rate of less than 10 cm/s.

The composition according to the invention can be prepared using any known method, for example simple mixing of the different components with one another.

### Heat Transfer Composition

According to one embodiment, the composition according to the invention is a heat transfer fluid.

The present invention also relates to a heat transfer composition comprising (preferably constituted of) the aforementioned composition according to the invention, and at least one additive preferably chosen from among nanoparticles, stabilizers, surfactants, tracers, fluorescent agents, odorizing agents, lubricants and solubilizing agents. Preferably, the additive is chosen from among lubricants, and in particular polyol ester-based lubricants.

The additives can in particular be chosen from among nanoparticles, stabilizers, surfactants, tracers, fluorescent agents, odorizing agents, lubricants and solubilizing agents.

“Heat transfer compound”, respectively “heat transfer fluid” or “refrigerant” refers to a compound, respectively a fluid, capable of absorbing by heat evaporating at a low temperature and low pressure and discharging heat by condensing at a high temperature and high pressure, in a vapor compression circuit. In general, a heat transfer fluid can comprise just one, two, three or more than three heat transfer compounds.

“Heat transfer composition” refers to a composition comprising a heat transfer fluid and optionally one or more additives that are not heat transfer compounds for the considered application.

The stabilizer(s), when they are present, preferably represent no more than 5% by mass in the heat transfer composition. The stabilizers in particular include nitromethane, ascorbic acid, terephthalic acid, azoles such as tolutriazole or benzotriazole, phenolic compounds such as tocopherol, hydroquinone, t-butyl hydroquinone, 2,6-di-tert-butyl-4-methylphenol, epoxides (alkyl optionally fluorinated or perfluorinated or alkenyl or aromatic) such as n-butyl glycidyl ether, hexanediol diglycidyl ether, allyl glycidyl ether, butylphenylglycidyl ether, phosphites, phosphonates, thiols and lactones.

Nanoparticles that may be used in particular include charcoal nanoparticles, metal oxides (copper, aluminum), TiO₂, Al₂O₃, MoS₂, etc.

Tracers (that can be detected) include hydrofluorocarbons, which may or may not be deuterated, deuterated hydrocarbons, perfluorocarbons, fluoroethers, brominated compounds, iodized compounds, alcohols, aldehydes, ketones, nitrous oxide and combinations thereof. The tracer is different from the heat transfer compound(s) making up the heat transfer fluid.

Solubilizing agents include hydrocarbons, dimethyl ether, polyoxyalkylene ethers, amides, ketones, nitriles, chlorocarbons, esters, lactones, aryl ethers, fluoroethers and 1,1,1-trifluoroalkanes. The solubilizing agent is different from the heat transfer compound(s) making up the heat transfer fluid.

Fluorescent agents include naphthalimides, perylenes, coumarins, anthracenes, phenanthracenes, xanthenes, thioxanthenes, naphthoxanthenes, fluoresceins and derivatives and combinations thereof.

Odorizing agents include alkylacrylates, allylacrylates, acrylic acids, acrylesters, alkylethers, alkylesters, alkynes, aldehydes, thiols, thioethers, disulfides, allylisothiocyanates, alcanoic acids, amines, norbornenes, derivatives norbornenes, cyclohexene, heterocyclic aromatic compounds, ascaridole, o-methoxy(methyl)-phenol and combinations thereof.

In the context of the invention, the terms “lubricant”, “lubricating oil” and “lubrication oil” are used as equivalents.

Lubricants that can be used in particular include mineral oils, silicone oils, natural paraffins, naphthenes, synthetic paraffins, alkylbenzenes, poly-alpha olefins, polyalkene glycols, polyol esters (polyol esters) and/or polyvinyl ethers.

According to one embodiment, the lubricant contains polyol esters. In particular, the lubricant comprises one or more polyol ester(s).

According to one embodiment, the polyol esters are obtained by reaction of at least one polyol, with a carboxylic acid or with a mixture of carboxylic acids.

In the context of the invention, the term “carboxylic acid” covers both monocarboxylic and polycarboxylic acids, for example a dicarboxylic acid. In the context of the invention, and unless otherwise mentioned, “polyol” refers to a compound containing at least two (—OH) hydroxyl groups.

Polyol Esters A)

According to one embodiment, the polyol esters according to the invention satisfy the following formula (I):

R¹[OC(O)R²]ₙ (I)

wherein:
R¹ is a linear or branched hydrocarbon substituent, optionally substituted by at least one hydroxyl group and/or comprising at least one heteroatom chosen from the group constituted of —O—, —N—, and —S—;
each R² is, independently of each other, chosen from the group constituted of:
   i) H;
   ii) an aliphatic hydrocarbon substituent;
   iii) a branched hydrocarbon substituent;
   iv) a mixture of a substituent ii) and/or iii), with an aliphatic hydrocarbon substituent comprising from 8 to 14 carbon atoms; and
n is an integer of at least 2.

In the context of the invention, a hydrocarbon substituent refers to a substituent constituted of carbon and hydrogen atoms.

According to one embodiment, the polyols have the following general formula (II):

R¹(OH)ₙ (II)

wherein:
R¹ is a linear or branched hydrocarbon substituent, optionally substituted by at least one hydroxyl group, preferably by two hydroxyl groups, and/or comprising at least one heteroatom chosen from the group constituted by —O—, —N—, and —S—; and
n is an integer of at least 2.

Preferably, R¹ represents a linear or branched hydrocarbon substituent, comprising from 4 to 40 carbon atoms and preferably from 4 to 20 carbon atoms.

Preferably, R¹ is a linear or branched hydrocarbon substituent, comprising at least one oxygen atom.

Preferably, R¹ is a branched hydrocarbon substituent comprising from 4 to 10 carbon atoms, preferably 5 carbon atoms, substituted by two hydroxyl groups.

According to one preferred embodiment, the polyols comprise from 2 to 10 hydroxyl groups, preferably from 2 to 6 hydroxyl groups.

The polyols according to the invention can comprise one or more oxyalkylene groups, in this particular case polyetherpolyols.

The polyols according to the invention can also comprise one or more nitrogen atoms. For example, the polyols can be alcohol amines containing from 3 to 6 OH groups. Preferably, the polyols are alcohol amines containing at least two OH groups, preferably at least three.

According to the present invention, the preferred polyols are chosen from the group constituted of ethylene glycol, diethylene glycol, triethylene glycol, propylene glycol, dipropylene glycol, glycerol, neopentyl glycol, 1,2-butanediol, 1,4-butanebiol, 1,3-butanediol, pentaerythritol, dipentaerythritol, tripentaerythritol, triglycerol, trimethylolpropane, sorbitol, hexaglycerol, and mixtures thereof. Preferably, the polyol is pentaerythritol or dipentaerythritol.

According to the invention, the carboxylic acids may satisfy the following general formula:

R²COOH (III)

wherein:
R² is chosen from the group constituted of:
   i) H;
   ii) an aliphatic hydrocarbon substituent;
   iii) a branched hydrocarbon substituent;
   iv) a mixture of a substituent ii) and/or iii), with an aliphatic hydrocarbon substituent comprising from 8 to 14 carbon atoms.

Preferably, R² is an aliphatic hydrocarbon substituent of 1 to 10, preferably from 1 to 7 carbon atoms, and in particular from 1 to 6 carbon atoms.

Preferably, R² is a branched hydrocarbon substituent of 4 to 20 carbon atoms, in particular 5 to 14 carbon atoms, and preferably 6 to 8 carbon atoms.

According to one preferred embodiment, a branched hydrocarbon substituent has the following formula (IV):

—C(R³)R⁴)(R⁵) (IV)

wherein R³, R⁴ and R⁵ are, independently of one another, an alkyl group, and at least one of the alkyl groups contains at least two carbon atoms. Such branched alkyl groups, once linked to the carboxyl group, are known under the name “neo group”, and the corresponding acid as “neo acid.” Preferably, R³ and R⁴ are methyl groups and R¹⁰ is an alkyl group comprising at least two carbon atoms.

According to the invention, the substituent R² can comprise one or more carboxyl groups, or ester groups such as —COOR⁶, with R⁶ representing an alkyl, hydroxyalkyl or hydroxyalkyloxy alkyl group.

Preferably, the R²COOH acid with formula (III) is a monocarboxylic acid.

Examples of carboxylic acids in which the hydrocarbon substituent is aliphatic are in particular: formic acid, acetic acid, propionic acid, butyric acid, pentanoic acid, hexanoic acid and heptanoic acid.

Examples of carboxylic acids in which the hydrocarbon substituent is branched are in particular: 2-ethyl-n-butyric acid, 2-hexyldecanoic acid, isostearic acid, 2-methyl-hexanoic acid, 2-methylbutanoic acid, 3-methylbutanoic acid, 3,5,5-trimethyl-hexanoic acid, 2-ethylhexanoic acid, neoheptanoic acid, and neodecanoic acid.

The third type of carboxylic acids that can be used in the preparation of polyol esters with formula (I) are carboxylic acids comprising an aliphatic hydrocarbon substituent comprising from 8 to 14 carbon atoms. Examples include: decanoic acid, dodecanoic acid, lauric acid, stearic acid, myristic acid, behenic acid, etc. Dicarboxylic acids include maleic acid, succinic acid, adipic acid, sebacic acid, etc.

According to one preferred embodiment, the carboxylic acids used to prepare the polyol esters of formula (I) comprise a mixture of monocarboxylic and dicarboxylic acids, the proportion of monocarboxylic acids making up the majority. The presence of dicarboxylic acids in particular results in the formation of polyol esters with a high viscosity.

In particular, the formation reaction of the polyol esters with formula (I) by reaction between the carboxylic acid and the polyols is a reaction catalyzed by an acid. It is in particular a reversible reaction, which can be completed by the use of a large quantity of acid or by the elimination of the water formed during the reaction.

The esterification reaction can be done in the presence of organic or inorganic acids, such as sulfuric acid, phosphoric acid, etc.

Preferably, the reaction is done in the absence of any catalyst.

The quantity of carboxylic acid and polyol can vary in the mixture depending on the desired results. In the specific case where all of the hydroxyl groups are esterified, a sufficient quantity of carboxylic acid must be added to react with all of the hydroxyls.

According to one embodiment, during the use of carboxylic acid mixtures, the latter can react sequentially with the polyols.

According to one preferred embodiment, during the use of mixtures of carboxylic acids, a polyol reacts first with a carboxylic acid, typically the carboxylic acid with the highest molecular weight, followed by the reaction with the carboxylic acid having an aliphatic hydrocarbon chain.

According to one embodiment, the esters can be formed by reaction between the carboxylic acids (or their anhydride or ester derivatives) with the polyols, in the presence of acids at high temperature, while removing the water formed during the reaction. Typically, the reaction can be done at a temperature of 75 to 200° C.

According to another embodiment, the formed polyol esters can comprise hydroxyl groups not all having reacted, in which case they are partially esterified polyol esters.

According to one preferred embodiment, the polyol esters are obtained from pentaerythritol alcohol, and a mixture of carboxylic acids: isononanoic acid, at least one acid having an aliphatic hydrocarbon substituent of 8 to 10 carbon atoms, and heptanoic acid. The preferred polyol esters are obtained from pentaerythritol, and a mixture of 70% isononanoic acid, at least 15% of at least one carboxylic acid having an aliphatic hydrocarbon substituent of 8 to 10 carbon atoms, and 15% heptanoic acid. One example is the Solest 68 oil marketed by CPI Engineering Services Inc.

According to one preferred embodiment, the polyol esters are obtained from dipentaerythritol alcohol, and a mixture of carboxylic acids: isononanoic acid, at least one acid having an aliphatic hydrocarbon substituent of 8 to 10 carbon atoms, and heptanoic acid

Preferably, the polyol esters of the invention have one of the following formulas (I-A) or (I-B):

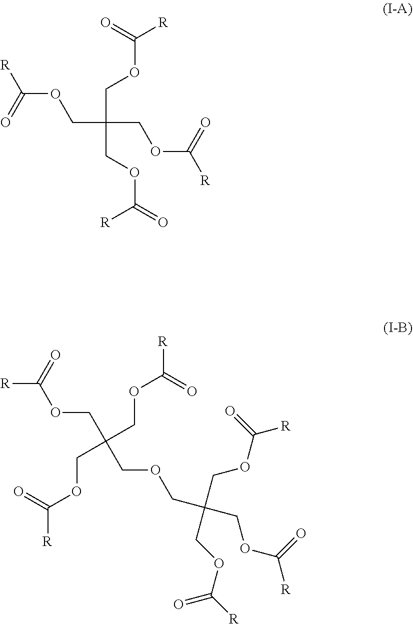

wherein each R represents, independently of one another:
an aliphatic hydrocarbon substituent comprising from 1 to 10, preferably from 2 to 9, preferably from 4 to 9 carbon atoms, and particularly from 1 to 6 carbon atoms.
a branched hydrocarbon substituent comprising from 4 to 20 carbon atoms, particularly from 4 to 14 carbon atoms, and preferably from 4 to 9 carbon atoms.

In particular, the polyol esters of formula (I-A) or formula (I-B) comprise different substituents R.

One preferred polyol ester is an ester with formula (I-A) in which R is chosen from among:
an aliphatic hydrocarbon substituent comprising 4 carbon atoms; and/or
an aliphatic hydrocarbon substituent comprising 6 carbon atoms; and/or
an aliphatic hydrocarbon substituent comprising 7 carbon atoms; and/or
an aliphatic hydrocarbon substituent comprising 8 carbon atoms; and/or
an aliphatic hydrocarbon substituent comprising 9 carbon atoms; and/or
a branched hydrocarbon substituent comprising 4 carbon atoms; and/or
a branched hydrocarbon substituent comprising 5 carbon atoms; and/or
a branched hydrocarbon substituent comprising 7 carbon atoms; and/or
a branched hydrocarbon substituent comprising 8 carbon atoms; and/or
a branched hydrocarbon substituent comprising 9 carbon atoms.

One preferred polyol ester is an ester with formula (I-B) in which R is chosen from among:
an aliphatic hydrocarbon substituent comprising 4 carbon atoms; and/or
an aliphatic hydrocarbon substituent comprising 6 carbon atoms; and/or
an aliphatic hydrocarbon substituent comprising 7 carbon atoms; and/or
an aliphatic hydrocarbon substituent comprising 8 carbon atoms; and/or
an aliphatic hydrocarbon substituent comprising 9 carbon atoms; and/or
a branched hydrocarbon substituent comprising 4 carbon atoms; and/or
a branched hydrocarbon substituent comprising 5 carbon atoms; and/or
a branched hydrocarbon substituent comprising 7 carbon atoms; and/or
a branched hydrocarbon substituent comprising 8 carbon atoms; and/or
a branched hydrocarbon substituent comprising 9 carbon atoms.

Polyol Esters B)

According to another embodiment, the polyol esters of the invention comprise at least one ester of one or more branched carboxylic acids comprising no more than 8 carbon atoms. The ester is in particular obtained by reacting said branched carboxylic acid with one or more polyols.

Preferably, the branched carboxylic acid comprises at least 5 carbon atoms. In particular, the branched carboxylic acid comprises from 5 to 8 carbon atoms, and preferably it contains 5 carbon atoms.

Preferably, the aforementioned branched carboxylic acid does not comprise 9 carbon atoms. In particular, said carboxylic acid is not 3,5,5-trimethylhexanoic acid.

According to one preferred embodiment, the branched carboxylic acid is chosen from among 2-methylbutanoic acid, 3-methylbutanoic acid, and mixtures thereof.

According to one preferred embodiment, the polyol is chosen from the group constituted of neopentyl glycol, glycerol, trimethylol propane, pentaerythritol, dipentaerythritol, tripentaerythritol, and mixtures thereof.

According to one preferred embodiment, the polyol esters are obtained from:

i) a carboxylic acid chosen from among 2-methylbutanoic acid, 3-methylbutanoic acid, and mixtures thereof; and
ii) a polyol chosen from the group constituted of neopentyl glycol, glycerol, trimethylol propane, pentaerythritol, dipentaerythritol, tripentaerythritol, and mixtures thereof.

Preferably, the polyol ester is that obtained from 2-methylbutanoic acid and pentaerythritol.

Preferably, the polyol ester is that obtained from 2-methylbutanoic acid and dipentaerythritol.

Preferably, the polyol ester is that obtained from 3-methylbutanoic acid and pentaerythritol.

Preferably, the polyol ester is that obtained from 3-methylbutanoic acid and dipentaerythritol.

Preferably, the polyol ester is that obtained from 2-methylbutanoic acid and neopentyl glycol.

Polyol Esters C)

According to another embodiment, the polyol esters according to the invention are poly(neopentylpolyol) esters obtained by:

i) reacting a neopentylpolyol having the following formula (V):

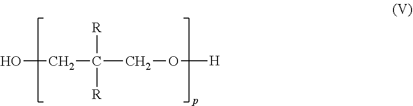

wherein:
each R represents, independently of each other, CH₃, C₂H₅ or CH₂OH;
p is an integer ranging from 1 to 4;

with at least one monocarboxylic acid having 2 to 15 carbon atoms, and in the presence of an acid catalyst, the molar ratio between the carboxyl groups and the hydroxyl groups being less than 1:1, to form a partially esterified poly(neopentyl)polyol composition; and

ii) reacting the partially esterified poly(neopentyl)polyol composition obtained at the end of step i), with another carboxylic acid having 2 to 15 carbon atoms, to form the final composition of poly(neopentylpoly) ester(s).

Preferably, the reaction i) is done with a molar ratio of 1:4 to 1:2.

Preferably, the neopentylpolyol has the following formula (VI):

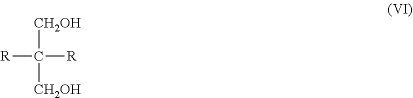

in which each R represents, independently of one another, CH₃, C₂H₅ or CH₂OH.

Preferred neopentylpolyols are those chosen from among pentaerythritol, dipentaerythritol, tripentaerythritol, tetraerythritol, trimethylolpropane, trimethylolethane, and neopentyl glycol. In particular, the neopentylpolyol is pentaerythritol.

Preferably, a single neopentylpolyol is used to produce the PEO-based lubricant. In some cases, two or more neopentylpolyols are used. This is in particular the case when a commercial pentaerythritol product comprises small quantities of dipentaerythritol, tripentaerythritol, and tetraerythritol.

According to one preferred embodiment, the aforementioned monocarboxylic acid comprises from 5 to 11 carbon atoms, preferably from 6 to 10 carbon atoms.

The monocarboxylic acids in particular have the following general formula (VII):

R′C(O)OH (VII)

wherein R′ is a linear or branched C1-C12 alkyl substituent, a C6-C12 aryl substituent, a C6-C30 aralkyl substituent. Preferably, R′ is a C4-C10, and preferably C5-C9, alkyl substituent.

In particular, the monocarboxylic acid is chosen from the group constituted of butanoic acid, pentanoic acid, hexanoic acid, heptanoic acid, n-octanoic acid, n-nonanoic acid, n-decanoic acid, 3-methylbutanoic acid, 2-methylbutanoic acid, 2,4-dimethylpentanoic acid, 2-ethylhexanoic acid, 3,3,5-trimethylhexanoic acid, benzoic acid, and mixtures thereof.

According to one preferred embodiment, the monocarboxylic acid is n-heptanoic acid, or a mixture of n-heptanoic acid with another linear monocarboxylic acid, in particular n-octanoic acid and/or n-decanoic acid. Such a monocarboxylic acid mixture can comprise between 15 and 100 mol % of heptanoic acid and between 85 and 0 mol % of other monocarboxylic acid(s). In particular, the mixture comprises between 75 and 100 mol % of heptanoic acid, and between 25 and 0 mol % of a mixture of octanoic acid and decanoic acid in a molar ratio 3: 2.

According to one preferred embodiment, the polyol esters comprise:

i) from 45 wt % to 55 wt % of a monopentaerythritol ester with at least one monocarboxylic acid having from 2 to 15 carbon atoms;

ii) less than 13 wt % of a dipentaerythritol ester with at least one monocarboxylic acid having from 2 to 15 carbon atoms;

iii) less than 10 wt % of a tripentaerythritol ester with at least one monocarboxylic acid having from 2 to 15 carbon atoms; and

iv) less than 25 wt % of a tetraerythritol ester and other pentaerythritol oligomers with at least one monocarboxylic acid having from 2 to 15 carbon atoms.

Polyol Esters D)

According to another embodiment, the polyol esters according to the invention satisfy the following formula (VIII):

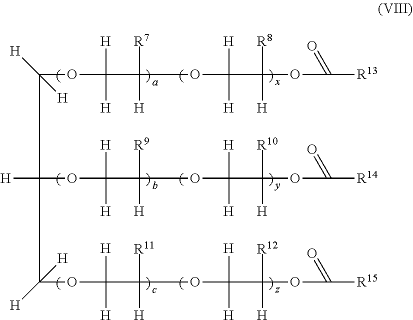

wherein:
_{R}⁷, R⁸, R⁹, R¹⁰, R¹¹ and R¹² are, independently of one another, H or CH₃;
a, b, c, y, x and z, are, independently of one another, an integer;
a+x, b+y, and c+z are, independently of one another, integers from 1 to 20;
R¹³, R¹⁴ and R¹⁵ are, independently of one another, chosen from the group constituted of aliphatic or branched alkyls, alkenyls, cycloalkyls, aryls, alkylaryls, arylalkyls, alkylcycloalkyls, cycloalkylalkyls, arylcycloalkyls, cycloalkylaryls, alkylcycloalkylaryls, alkylarylcycloalkyls, arylcycloalkylalkyls, arylalkylcycloalkyls, cycloalkylalkylaryl and cycloalkylarylalkyls,
R¹³, R¹⁴ and R¹⁵, having from 1 to 17 carbon atoms, and optionally being able to be substituted.

According to one preferred embodiment, each R¹³, R¹⁴ and R¹⁵ represents, independently of one another, a linear or branched alkyl group, an alkenyl group, a cycloalkyl group, said alkyl, alkenyl or cycloalkyl groups being able to comprise at least one heteroatom chosen from among N, O, Si, F or S. Preferably, each R¹³, R¹⁴ and R¹⁵ has, independently of one another, from 3 to 8 carbon atoms, preferably from 5 to 7 carbon atoms.

Preferably, a+x, b+y, and c+z are, independently of one another, integers from 1 to 10, preferably from 2 to 8, and still more preferably from 2 to 4.

Preferably, R⁷, R⁸, R⁹, R¹⁰, R¹¹ and R¹² represent H.

The polyol esters with formula (VIII) above can typically be prepared as described in paragraphs [0027] to [0030] of international application WO2012/177742.

In particular, the polyol esters with formula (VIII) are obtained by esterifying glycerol alkoxylates (as described in paragraph [0027] of WO2012/177742) with one or more monocarboxylic acids having from 2 to 18 carbon atoms.

In one preferred embodiment, the monocarboxylic acids have one of the following formulas:

R¹³COOH

R¹⁴COOH and

R¹⁵COOH

in which R¹³, R¹⁴ and R¹⁵ are as defined above. Derivatives of carboxylic acids can also be used, such as anhydrides, esters and acyl halides.

The esterification can be done with one or more monocarboxylic acids. Preferred monocarboxylic acids are those chosen from the group constituted of acetic acid, propanoic acid, butyric acid, isobutanoic acid, pivalic acid, pentanoic acid, isopentanoic acid, hexanoic acid, heptanoic acid, octanoic acid, 2-ethylhexanoic acid, 3,3,5-trimethylhexanoic acid, nonanoic acid, decanoic acid, neodecanoic acid, undecanoiec acid, dodecanoic acid, tridcanoic, myristic acid, pentadecanoic acid, palmitic acid, stearic acid, oleic acid, linoleic acid, palmitoleic acid, citronellic acid, undecenoic acid, lauric acid, undecylenic acid, linolenic acid, arachidic acid, behenic acid, tetrahydrobenzoic acid, abietic acid, hydrogenatied or not, 2-ethylhexanoic acid, furoic acid, benzoic acid, 4-acetylbenzoic acid, pyruvic acid, 4-tert-butyl-benzoic acid, naphthenic acid, 2-methyl benzoic acid, salicylic acid, isomers thereof, methyl esters thereof, and mixtures thereof.

Preferably, the esterification is done with one or more monocarboxylic acids chosen from the group constituted of pentanoic acid, 2-methylbutanoic acid, n-hexanoic acid, n-heptanoic acid, 3,3,5-trimethylhexanoic acid, 2-ethylhexanoic acid, n-octanoic acid, n-nonanoic acid and isononanoic acid.

Preferably, the esterification is done with one or more monocarboxylic acids chosen from the group constituted of butyric acid, isobutyric acid, n-pentanoic acid, 2-methylbutanoic acid, 3-methylbutanoic acid, n-hexanoic acid, n-heptanoic acid, n-octanoic acid, 2-ethylnexanoic acid, 3,3,5-trimethylhxanoic acid, n-nonanoic acid, decanoic acid, undecanoic acid, undecelenic acid, lauric acid, stearic acid, isostearic acid, and mixtures thereof.

According to another embodiment, the polyol esters according to the invention have the following formula (IX):

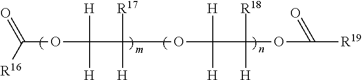

wherein:
each of R¹⁷ and R¹⁸ is, independently of one another, H or CH₃;
each of m and n is, independently of each other, an integer, where m+n is an integer ranging from 1 to 10;
R¹⁶ and R¹⁹ are, independently of one another, chosen from the group constituted of aliphatic or branched alkyls, alkenyls, cycloalkyls, aryls, alkylaryls, arylalkyls, alkylcycloalkyls, cycloalkylalkyls, arylcycloalkyls, cycloalkylaryls, alkylcycloalkylaryls, alkylarylcycloalkyls, arylcycloalkylalkyls, arylalkylcycloalkyls, cycloalkylalkylaryl and cycloalkylarylalkyls,
R¹⁶ and R¹⁹, having from 1 to 17 carbon atoms, and optionally being able to be substituted.

According to one preferred embodiment, each R¹⁶ and R¹⁹ represents, independently of one another, a linear or branched alkyl group, an alkenyl group, a cycloalkyl group, said aklyl, alkenyl or cycloalkyl groups being able to comprise at least one heteroatom chosen from among N, O, Si, F or S. Preferably, each R¹⁶ and R¹⁹ has, independently of one another, from 3 to 8 carbon atoms, preferably from 5 to 7 carbon atoms.

According to one preferred embodiment, each R¹⁷ and R¹⁸ represents H, and/or m+n is an integer from 2 to 8, from 4 to 10, from 2 to 5 or from 3 to 5. In particular, m+n is equal to 2, 3 or 4.

According to one preferred embodiment, the polyol esters with formula (IX) above are diesters of triethylene glycol, diesters of tetraethylene glycol, in particular with one or two monocarboxylic acids having from 4 to 9 carbon atoms.

The polyol esters with formula (IX) above can be prepared by esterifications of an ethylene glycol, a propylene glycol, or of an oligo- or polyalkylene glycol, (which can be an oligo- or polyethylene glycol, oligo- or polypropylene glycol, or a copolymer with ethylene glycol-polypropylene glycol block), with one or two monocarboxylic acids having from 2 to 18 carbon atoms. The esterification can be done identically to the esterification reaction carried out to prepare the polyol esters with formula (VIII) above.

In particular, monocarboxylic acids identical to those used to prepare the polyol esters with formula (VIII) above can be used to form the polyol esters with formula (IX).

According to one embodiment, the lubricant based on polyol esters according to the invention comprises from 20 to 80 wt %, preferably from 30 to 70 wt %, and preferentially from 40 to 60 wt % of at least one polyol ester with formula (VIII), and from 80 to 20 wt %, preferably from 70 to 30 wt %, and preferentially from 60 to 40 wt % of at least one polyol ester with formula (IX).

In general, certain alcohol functions may not be esterified during the esterification reaction, but their proportion remains low. Thus, the POEs can comprise between 0 and 5 mol % of CH₂OH units relative to the —CH₂—O—C(═O)— units.

The preferred POE lubricants according to the invention of those having a viscosity from 1 to 1000 centiStokes (cSt) at 40° C., preferably from 10 to 200 cSt, still more preferably from 20 to 100 cSt, and advantageously from 30 to 80 cSt.

The International classification of oils is in particular given by standard ISO3448-1992 (NF T60-141), according to which oils are designated by their average viscosity class measured at the temperature of 40° C.

### Uses

The composition according to the present invention is particularly suitable as a heat transfer fluid in refrigeration, air conditioning and heating.

The composition according to the present invention can be used in various applications to replace current refrigerants such as R455A (mixture of R32/R1234yf/CO₂: 21.5/75.5/3 wt %) or R454C (mixture of R1234yf/R32: 78.5/21.5 wt %).

The present invention relates to the use of the composition according to the invention to reduce the risks of ignition and/or explosion in case of refrigerant leak.

The low flammability of the composition advantageously allows it to be used in larger quantities in heat transfer facilities. The use of refrigerants based on flammability classes is in particular described in standard ISO 5149-1 (2014 version).

The present invention also relates to the use of a composition according to the invention or a heat transfer composition according to the invention, in a heat transfer system containing a vapor compression circuit.

According to one embodiment, the heat transfer system is:
an air conditioning system; or
a refrigeration system; or
a freezer system; or
a heat pump system.

The present invention also relates to a heat transfer method based on the use of a heat transfer facility containing a vapor compression circuit that comprises the composition according to the invention or the heat transfer composition according to the invention. The heat transfer method can be a method for heating or cooling a fluid or a body.

The composition according to the invention or the heat transfer composition can also be used in a method for producing mechanical work or electricity, in particular according to a Rankine cycle.

The invention also relates to a heat transfer facility comprising a vapor compression circuit containing the composition according to the invention or the heat transfer composition according to the invention.

According to one embodiment, this facility is chosen from among mobile or stationary refrigeration, heating (heat pump), air conditioning and freezing facilities, and heat engines.

It may in particular involve a heat pump facility, in which case the fluid or body that is heated (generally air and optionally one or more products, objects or bodies) is located in a site or a vehicle passenger compartment (for a moving facility). According to one particular embodiment, it involves an air conditioning facility, in which case the fluid or body that is cooled (generally air and optionally one or more products, objects or bodies) is located in a site or a vehicle passenger compartment (for a moving facility). It may in particular involve a refrigeration facility or a freezer facility (or cryogenic facility), in which case the fluid or body that is cooled generally comprises air and one or more products, objects or bodies, located in a site or a container.

The invention also relates to a method for heating or cooling a fluid or a body using a vapor compression circuit containing a heat transfer fluid or a heat transfer composition, said method successively comprising the evaporation of the fluid or the heat transfer composition, the compression of the fluid or the heat transfer composition, the condensation of the fluid or the heat transfer composition, and the expansion of the fluid or the heat transfer composition, wherein the heat transfer fluid is the composition according to the invention, or the heat transfer composition is that described above.

The invention also relates to a method for producing electricity using a heat engine, said method successively comprising the evaporation of the heat transfer fluid or a heat transfer composition, the expansion of the fluid or the heat transfer composition in a turbine making it possible to generate electricity, the condensation of the fluid or the heat transfer composition and the compression of the fluid or the heat transfer composition, wherein the heat transfer fluid is the composition according to the invention and the heat transfer composition is that described above.

The vapor compression circuit, containing a heat transfer fluid or composition according to the invention, comprises at least an evaporator, a compressor preferably with screw, a condenser and an expander, as well as transport lines for the fluid or the heat transfer composition between these elements. The evaporator and the condenser comprise a heat exchanger allowing an exchange of heat between the fluid or the heat transfer composition and another fluid or body.

The evaporator used in the context of the invention can be an expansion evaporator or a flooded evaporator. In an expansion evaporator, all of the aforementioned fluid or heat transfer composition is evaporated at the outlet of the evaporator, and the vapor phase is expanded.

In a flooded evaporator, the fluid/the heat transfer composition in liquid form does not evaporate completely. A flooded evaporator includes a liquid phase and vapor phase separator.

As a compressor, it is in particular possible to use a centrifugal compressor with one or more stages or a centrifugal mini-compressor. Rotary, piston or screw compressors can also be used.

According to one embodiment, the vapor compression circuit comprises a centrifugal compressor, and preferably a centrifugal compressor and a flooded evaporator.

According to another embodiment, the vapor compression circuit comprises a screw compressor, preferably twin-screw or mono-screw. In particular, the vapor compression circuit comprises a twin-screw compressor, able to implement a significant flow of oil, for example up to 6.3 L/s.

A centrifugal compressor is characterized in that it uses rotary elements to accelerate the fluid or the heat transfer composition radially; it typically comprises at least a rotor and a diffuser that are housed in an enclosure. The heat transfer fluid or the heat transfer composition is introduced at the center of the rotor and circulates toward the periphery of the rotor while undergoing an acceleration. Thus, on the one hand, the static pressure increases in the rotor, and above all on the other hand at the diffuser, the speed is converted into an increase in the static pressure. Each rotor/diffuser assembly constitutes a stage of the compressor. The centrifugal compressors can comprise from 1 to 12 stages, depending on the desired final pressure and the volume of fluid to be treated.

The compression rate is defined as the ratio of the absolute pressure of the fluid/heat transfer composition at the outlet to the absolute pressure of said fluid or said composition at the inlet.

The rotation speed for large centrifugal compressors is from 3000 to 7000 revolutions per minute. Small centrifugal compressors (or mini centrifugal compressors) generally operate at a rotation speed of from 40,000 to 70,000 revolutions per minute and include a small rotor (generally less than 0.15 m).

It is possible to use a rotor with several stages to improve the effectiveness of the compressor and to limit the energy cost (relative to a rotor with a single stage). For a system with two stages, the outlet of the first stage of the rotor supplies the inlet of the second rotor.

The two rotors can be mounted on a single axle. Each stage can provide a compression rate of the fluid of about 4 to 1, i.e., the absolute output pressure can be equal to about four times the absolute pressure upon suction. Examples of centrifugal compressors with two stages, in particular for automotive applications, are described in documents U.S. Pat. No. 5,065,990 and 5,363,674.

The centrifugal compressor can be driven by an electric motor or by a combustion engine (for example supplied by the exhaust gases of a vehicle, for mobile applications) or by meshing.

The facility can comprise coupling of the expander with a turbine to generate electricity (Rankine cycle).

The facility can also optionally comprise at least one heat transfer fluid circuit used to transmit heat (with or without state change) between the circuit of the heat transfer fluid or the heat transfer composition, and the fluid or body to be heated or cooled.

The facility can also optionally comprise two (or more) vapor compression circuits, containing identical or different heat transfer fluid/compositions. For example, the vapor compression circuits can be coupled to one another.

The vapor compression circuit operates according to a traditional vapor compression cycle. The cycle comprises the state change of the heat transfer fluid/composition from a liquid (or liquid/vapor diphasic) phase to a vapor phase at a relatively low pressure, then the compression of the fluid/composition to vapor phase at a relatively high pressure, the state change (condensation) of the heat transfer fluid/composition from the vapor phase to the liquid phase at a relatively high pressure, and the reduction of the pressure to start the cycle over again.

In the case of a cooling method, heat coming from the fluid or the body that is cooled (directly or indirectly, via a heat transfer fluid) is absorbed by the heat transfer fluid/composition, then the evaporation of the latter, at a relatively low temperature with respect to the environment. The cooling methods comprise air conditioning (with mobile facilities, for example in vehicles, or stationary ones), refrigeration and freezing or cryogenics methods. In the field of air conditioning, examples include household, commercial or industrial air conditioning, where the equipment used involves either chillers, or direct expansion equipment. In the refrigeration field, examples include household refrigeration, commercial refrigeration, cold rooms, the food industry, refrigerated transport (trucks, boats).

In the case of a heating method, heat is ceded (directly or indirectly, via a heat transfer fluid) from the heat transfer fluid/composition, during the condensation thereof, to the fluid or body that is heated, at a relatively high temperature with respect to the environment. The facility making it possible to perform the heat transfer is called “heat pump” in this case. It may in particular involve medium- and high-temperature heat pumps.

It is possible to use any type of heat exchanger to implement compositions according to the invention or heat transfer compositions according to the invention, and in particular co-current heat exchangers or, preferably, counter-current heat exchangers.

However, according to one preferred embodiment, the invention provides that the cooling and heating methods, and the corresponding facilities, comprise a counter-current heat exchanger, either the condenser, or the evaporator. Indeed, the compositions according to the invention or heat transfer composition defined above are particularly effective with counter-current heat exchangers. Preferably, both the evaporator and the condenser comprise a counter-current heat exchanger.

According to the invention, “counter-current heat exchanger” refers to a heat exchanger in which heat is exchanged between a first fluid and a second fluid, the first fluid at the inlet of the exchanger exchanging heat with the second fluid at the outlet of the exchanger, and the first fluid at the outlet of the exchanger exchanging heat with the second fluid at the inlet of the exchanger.

For example, the counter-current heat exchangers comprise devices in which the flow of the first fluid and the flow of the second fluid are in opposite directions, or practically opposite. The exchangers operating in cross-current mode with counter-current tendency are also included among the counter-current heat exchangers within the meaning of the present application.

In “low-temperature refrigeration” methods, the entry temperature of the composition according to the invention or heat transfer composition into the evaporator is preferably from −45° C. to −15° C., in particular from −40° C. to −20° C., still more particularly preferably from −35° C. to −25° C. and for example about −30° C. or −20° C.; and the beginning of condensation temperature of the composition according to the invention or heat transfer compositions at the condenser is preferably from 25° C. to 80° C., in particular from 30° C. to 60° C., still more particularly preferably from 35° C. to 55° C. and for example about 40° C. In “moderate-temperature refrigeration” methods, the entry temperature of the composition according to the invention or heat transfer composition into the evaporator is preferably from −20° C. to 10° C., in particular from −15° C. to 5° C., still more particularly preferably from −10° C. to 0° C. and for example about −5° C.; and the beginning of condensation temperature of the composition according to the invention or heat transfer composition at the condenser is preferably from 25° C. to 80° C., in particular from 30° C. to 60° C., still more particularly preferably from 35° C. to 55° C. and for example about 50° C. These methods can be a refrigeration or air conditioning methods.

In “moderate-temperature heating” methods, the entry temperature of the composition according to the invention or heat transfer composition into the evaporator is preferably from −20° C. to 10° C., in particular from −15° C. to 5° C., still more particularly preferably from −10° C. to 0° C. and for example about −5° C.; and the beginning of condensation temperature of the composition according to the invention or heat transfer composition at the condenser is preferably from 25° C. to 80° C., in particular from 30° C. to 60° C., still more particularly preferably from 35° C. to 55° C. and for example about 50° C.

All of the embodiments described above can be combined with one another.

In the scope of the invention, “between x and y,” or “from x to y,” are understood to mean an interval in which the limits x and y are included. For example, the range “between 1 and 1.9%” in particular includes the values 1 and 1.9%.

The following examples illustrate the invention without limiting it thereto.

### EXPERIMENTAL PART

### Example 1

The following mixtures A to F were prepared from R32, R1234yf and propane, with a constant composition of 21.5 wt % of R32. The composition of the propane was varied from 1.8 to 30 wt % relative to the total weight of the composition.

TABLE 1

| | | | R290 | Flame | |
|---|---|---|---|---|---|
| | R1234yf | R32 | (propane) | spread rate | |
| Mixture | (Wt %) | (wt %) | (wt %) | (cm/s) | |
| A | 76.7 | 21.5 | 1.8 | <10 | Invention |
| B | 76.6 | 21.5 | 1.9 | <10 | Invention |
| C | 70.5 | 21.5 | 8 | >10 | Comparative |
| D | 68.5 | 21.5 | 10 | >10 | Comparative |
| E | 58.5 | 21.5 | 20 | >10 | Comparative |
| F | 48.5 | 21.5 | 30 | >10 | Comparative |

The flame spread rates are measured as indicated in standard ASHRAE 34-2013. The experimental device for measuring the flame spread rate uses the vertical glass tube method (tube number 2, length 150 cm, diameter 40 cm). Using two tubes makes it possible to conduct two tests with the same concentration at the same time. The tubes are in particular provided with tungsten electrodes, the latter are placed at the bottom of each tube, 6.35 mm (¼ inch) apart, and are connected to a 15 kV, 30 mA generator.

Following the fractionating analysis pursuant to standard ASHRAE 34-2013, the most critical composition of these mixtures (WCFF) is for a leak test at the boiling temperature +10° C. and for filling of the cylinder at 90% with liquid phase at a temperature of 54.4° C. (ASHRAE STANDARD 34-2013 appendix B, paragraph B2).

The calculations were done with the Refprop software version 9.

The compositions and the flame spread rates after leak (WCFF) are the following:

TABLE 2

| | WCFF compositions | | | |
|---|---|---|---|---|
| Mixture | R1234yf | R32 | propane | Flame spread rate (cm/s) |
| A | 49.4 | 44.9 | 5.7 | <10 |
| B | 47.1 | 46.4 | 6.5 | <10 |
| C | 36.21 | 45 | 18.8 | >10 |
| D | 33.26 | 44.8 | 22 | >10 |
| E | 24.4 | 45.3 | 30.3 | >10 |
| F | 19.94 | 47.4 | 32.6 | >10 |

The compositions after leak of mixtures A and B were also validated by measurements.

### Example 2

Consider a low-temperature refrigeration facility that operates between an average evaporation temperature at -35° C., an average condensation temperature at 45° C., evaporation at 10° C. and subcooling at 5° C.

The isentropic efficiency of the compressor is 55%.

TABLE 3

| | | | | | Temperature (° C.) | | | | | | | | |
|---|---|---|---|---|---|---|---|---|---|---|---|---|---|
| | | | | | | evaporator | | condenser | condenser | evaporator | | | |
| | | | P (bar) | | evaporator | vapor | compressor | vapor | liquid | temperature | pressure | % | % |
| | | | Condenser | Evaporator | inlet | saturation | outlet | saturated | saturated | slide | ratio | CAP | COP |
| Wt % | | | R454C | | | | | | | | | | |
| R32 | R1234yf | propane | 18.0 | 1.3 | −37.0 | −32.8 | 118 | 48.4 | 41.9 | 4.2 | 14.2 | 100 | 100 |
| 21.5 | 77.5 | 1.0 | 18.2 | 1.3 | −37.2 | −32.8 | 119 | 48.4 | 41.5 | 4.4 | 14.1 | 101 | 100 |
| 21.5 | 77.3 | 1.2 | 18.3 | 1.3 | −37.3 | −32.8 | 119 | 48.4 | 41.5 | 4.5 | 14.1 | 102 | 100 |
| 21.0 | 77.6 | 1.4 | 18.2 | 1.3 | −37.3 | −32.8 | 118 | 48.4 | 41.3 | 4.5 | 14.1 | 101 | 100 |
| 21.5 | 77.1 | 1.4 | 18.3 | 1.3 | −37.3 | −32.8 | 119 | 48.4 | 41.4 | 4.5 | 14.1 | 102 | 100 |
| 21.0 | 77.3 | 1.7 | 18.2 | 1.3 | −37.4 | −32.8 | 118 | 48.4 | 41.2 | 4.5 | 14.1 | 101 | 100 |
| 21.5 | 76.8/ | 1.7 | 18.4 | 1.3 | −37.4 | −32.8 | 119 | 48.4 | 41.3 | 4.6 | 14.1 | 102 | 100 |
| 21.0 | 77.2 | 1.8 | 18.3 | 1.3 | −37.4 | −32.8 | 118 | 48.4 | 41.2 | 4.6 | 14.1 | 102 | 100 |
| 21.5 | 76.7 | 1.8 | 18.4 | 1.3 | −37.4 | −32.8 | 119 | 48.4 | 41.3 | 4.6 | 14.1 | 102 | 100 |
| 21.0 | 77.1 | 1.9 | 18.4 | 1.3 | −37.2 | −32.7 | 118 | 48.6 | 41.4 | 4.6 | 14.1 | 102 | 100 |
| 21.5 | 76.6 | 1.9 | 18.5 | 1.3 | −37.3 | −32.7 | 119 | 48.6 | 41.4 | 4.6 | 14.1 | 103 | 100 |

The compositions advantageously have a volumetric capacity greater than that of the R454C mixture.

1. A composition comprising between 74 wt % to 80 wt % of 2,3,3,3-tetrafluoropropene, from 19 wt % to 25 wt % of difluoromethane, and from 1 to 1.9 wt % of propane, preferably from 1 to 1.8 wt % of propane, relative to the total weight of the composition.)

2. The composition according to claim 1, wherein the weight content of propane is between 1.2% and 1.9%.

3. The composition according to claim 1, wherein the weight content of 2,3,3,3-tetrafluoropropene is between 76% and 78%.

4. The composition according to claim 1, comprising from 74.1 wt % to 79.1 wt % of 2,3,3,3-tetrafluoropropene, from 19 wt % to 24 wt % of difluoromethane, and from 1 to 1.9 wt % of propane, relative to the total weight of the composition.

5. The composition according to claim 1, comprising from 76 wt % to 79 wt % of 2,3,3,3-tetrafluoropropene, from 20 wt % to 23 wt % of difluoromethane, and from 1 wt % to 1.9 wt % of propane, relative to the total weight of the composition.

6. The composition according to claim 1, chosen from among one of the following compositions:
76.7 wt % (±0.5%) of 2,3,3,3-tetrafluoropropene, 21.5 wt % (±0.5%) of difluoromethane, and 1.8 wt % (±0.1%) of propane, relative to the total weight of the composition;
76.7 wt % of 2,3,3,3-tetrafluoropropene, 21.5 wt % of difluoromethane, and 1.8 wt % of propane, relative to the total weight of the composition;
76.6 wt % of 2,3,3,3-tetrafluoropropene, 21.5 wt % of difluoromethane, and 1.9 wt % of propane, relative to the total weight of the composition;
77.3 wt % (±0.5%) of 2,3,3,3-tetrafluoropropene, 21.5 wt % (±0.5%) of difluoromethane, and 1.2 wt % (±0.2%) of propane, relative to the total weight of the composition;
77.5 wt % of 2,3,3,3-tetrafluoropropene, 21.5 wt % of difluoromethane, and 1.0 wt % of propane, relative to the total weight of the composition;
77.3 wt % of 2,3,3,3-tetrafluoropropene, 21.5 wt % of difluoromethane, and 1.2 wt % of propane, relative to the total weight of the composition;
77.1 wt % of 2,3,3,3-tetrafluoropropene, 21.5 wt % of difluoromethane, and 1.4 wt % of propane, relative to the total weight of the composition;
77.6 wt % of 2,3,3,3-tetrafluoropropene, 21.0 wt % of difluoromethane, and 1.4 wt % of propane, relative to the total weight of the composition;
77.0 wt % (±0.5%) of 2,3,3,3-tetrafluoropropene, 21.5 wt % (±0.5%) of difluoromethane, and 1.5 wt % (±0.4%) of propane, relative to the total weight of the composition;
77.3 wt % of 2,3,3,3-tetrafluoropropene, 21.0 wt % of difluoromethane, and 1.7 wt % of propane, relative to the total weight of the composition;
76.8 wt % of 2,3,3,3-tetrafluoropropene, 21.5 wt % of difluoromethane, and 1.7 wt % of propane, relative to the total weight of the composition;
77.2 wt % of 2,3,3,3-tetrafluoropropene, 21.0 wt % of difluoromethane, and 1.8 wt % of propane, relative to the total weight of the composition;
76.7 wt % of 2,3,3,3-tetrafluoropropene, 21.5 wt % of difluoromethane, and 1.8 wt % of propane, relative to the total weight of the composition;
77.1 wt % of 2,3,3,3-tetrafluoropropene, 21.0 wt % of difluoromethane, and 1.9 wt % of propane, relative to the total weight of the composition;
76.6 wt % of 2,3,3,3-tetrafluoropropene, 21.5 wt % of difluoromethane, and 1.9 wt % of propane, relative to the total weight of the composition.

7. The composition according to claim 1, wherein it has a flame spread rate of less than 10 cm/s.

8. A heat transfer fluid comprising the composition according to claim 1.

9. A method of replacing R455A or R454C, the method comprising replacing R455A or R454C with the composition according to claim 1.

10. A heat transfer composition comprising a composition according to claim 1, and at least one additive.

11. A heat transfer system comprising a composition according to claim 1, wherein the heat transfer system comprises a vapor compression circuit.

12. A heat transfer facility comprising a vapor compression circuit containing the composition according to claim 1, wherein the heat transfer facility is chosen from among the mobile or stationary heating facilities by heat pump, air conditioning, refrigeration, freezing and heat engines.

13. A method for heating or cooling a fluid or a body using a vapor compression circuit containing a heat transfer fluid or a heat transfer composition, said method successively comprising the evaporation of the fluid or the heat transfer composition, the compression of the fluid or the heat transfer composition, the condensation of the fluid or the heat transfer composition, and the expansion of the fluid or the heat transfer composition, wherein the heat transfer fluid is the composition according claim 1.
